(19) United States
(12) Patent Application Publication
(10) Pub. No.: US 2006/0238297 A1
(43) Pub. Date: Oct. 26, 2006

(54) SYSTEM AND METHOD FOR INTEGRATED GARAGE DOOR OPENER AND VEHICLE ENTRY USING MULTI-FREQUENCY TRANSMITTER

(75) Inventors: Tom Q. Tang, Novi, MI (US); Yi Luo, Ypsilanti, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield (US)

(21) Appl. No.: 10/908,042

(22) Filed: Apr. 26, 2005

(51) Int. Cl. H04Q 1/00; G05B 19/00

(52) U.S. Cl. 340/5.64; 340/5.72; 340/5.71

(57) ABSTRACT

A portable device for controlling a vehicle remote keyless entry (RKE) system and a garage door opener (GDO), the device including a controller and a multi-frequency transmitter. The controller generates a function code in response to an operator demand signal and selects between a first and second transmission frequency. The operator demand signal is at least one of a RKE demand signal and a GDO demand signal. The first frequency is selected when the function code is generated in response to a RKE demand signal and the second frequency is selected when the function code is generated in response to a GDO demand signal. The multi-frequency transmitter is electrically coupled to the controller and an antenna. The multi-frequency transmitter transmits the generated function code to at least one of a vehicle remote keyless entry system and a garage door opener at the selected frequency.

### BACKGROUND OF THE INVENTION

1. Field of the Invention

The present invention relates to a system and method for integrated garage door opener and vehicle entry using a multi-frequency transmitter.

2. Background Art

It is known in the garage door industry to provide for wireless operation of the door, such as through the use of garage door opener (GDO) systems. Such GDO systems typically use a hand-held or vehicle mounted remote transmitter. Currently available GDO transmitters generally transmit radio frequency (RF) signals to a transponder and/or control unit that is coupled to the garage door. The unit controls the operation of the garage door via the coupling based upon signals received from the GDO transmitter. Basic garage door control includes opening (i.e., raising) or closing (i.e., lowering) the door, and activating (i.e., turning on) or deactivating (i.e., turning off) a light that may me implemented on the control unit.

Universal garage door openers (UGDO) are also known in the garage door industry. UGDOs are transmitters designed to function with multiple makes and/or models of GDOs. Because UGDOs may be implemented in conjunction with a wide variety of GDOs, UGDOs are generally user configurable. That is, prior to operation, the user must perform some step to configure the UGDO to recognize the particular make/model of the user's GDO.

It is known in the automotive industry to provide for remote vehicle access, such as through the use of remote keyless entry (RKE) systems. Such RKE systems typically use a hand-held remote transmitter, which is commonly referred to as a “fob” or “card.” Currently available RKE fobs may be separate units, or may be part of an ignition key head. Such RKE fobs generally transmit radio frequency (RF) signals to a vehicle in order to lock or unlock vehicle doors, open or close a vehicle sliding door, unlock a vehicle trunk, activate internal and/or external vehicle lights, activate a “panic” alarm, and/or perform a variety of other functions.

RKE systems may be characterized as active or passive systems. In active RKE systems, a switch or pushbutton on the remote transmitter must be activated by an operator in order to have a desired remote access function performed, such as locking or unlocking the vehicle doors. In passive RKE systems, however, no such switch or pushbutton activation by an operator is required in order to perform a desired remote access function.

More specifically, in a passive RKE system, a remote transponder, which again may be referred to as a “fob” or a “card,” is typically provided for communicating with a transponder and/or control unit installed in the vehicle. The vehicle transponder and/or control unit is provided in communication with door locking mechanisms to lock and unlock the vehicle doors in response to lock or unlock signals received from the remote transponder within some pre-defined range. In that regard, the remote transponder is carried by an operator and is designed to automatically unlock the vehicle as the operator approaches the vehicle, without the need for operation of any switch or pushbutton by the operator. Similarly, the system is further designed to automatically lock the vehicle as the operator, carrying the remote transponder, moves away from the vehicle.

Such prior art garage door opener and vehicle remote keyless entry systems, however, are independent, distinct systems. That is, such systems do not interact with one another or share components. In that regard, the integration of garage door control with vehicle remote keyless entry control may reduce cost through the use of shared, combined or integrated components. Such a system may further provide space saving and convenience benefits through a single, portable control unit.

### SUMMARY OF THE INVENTION

Accordingly, the present invention provides a system and method for integrated garage door opener and vehicle remote keyless entry.

According to the present invention, then, a portable device is provided for controlling a vehicle remote keyless entry (RKE) system and a garage door opener (GDO). The device comprises a controller for generating a function code in response to an operator demand signal and for selecting between a first and second transmission frequency. The operator demand signal is at least one of a RKE demand signal and a GDO demand signal. The first frequency is selected when the function code is generated in response to a RKE demand signal and the second frequency is selected when the function code is generated in response to a GDO demand signal. The device further comprises a multi-frequency transmitter electrically coupled to the controller and an antenna for transmitting the generated function code to at least one of a vehicle remote keyless entry system and a garage door opener at the selected frequency.

Also according to the present invention, a system is provided for controlling a vehicle remote keyless entry system and a garage door opener. The system comprises a vehicle having a remote keyless entry system, a garage door opener, and a portable device. The portable device is in electronic communication with the RKE system and the GDO. The device includes a controller electrically coupled to a multi-frequency transmitter such that the controller generates and the transmitter transmits a RKE function code at a first frequency in response to a RKE operator demand signal. The controller also generates and the transmitter also transmits a GDO function code at a second frequency in response to a GDO operator demand signal.

Still further according to the present invention, a method is provided for controlling a vehicle remote keyless entry system and a garage door opener using a portable device. The portable device includes a controller electrically coupled to a multi-frequency transmitter. The method comprises the steps of determining a first and second frequency wherein the first frequency is an operating frequency of the RKE system and the second frequency is an operating frequency of the GDO, determining when at least one of a RKE operator demand signal and a GDO operator demand signal is presented to the controller, generating a RKE function code and a RKE security code using a predetermined RKE coding scheme when a RKE operator demand signal is presented to the controller, generating a GDO function code and a GDO security code using a predetermined GDO coding scheme when a GDO operator demand signal is presented to the controller, transmitting the RKE function code and the RKE security code at the first frequency using the multi-frequency transmitter when a RKE operator demand signal is presented to the controller, and transmitting the GDO function code and the GDO security code at the second frequency using the multi-frequency transmitter when a GDO operator demand signal is presented to the controller.

These and other features and advantages of the present invention will be readily apparent upon consideration of the following detailed description of the invention in conjunction with the accompanying drawings.

### BRIEF DESCRIPTION OF THE DRAWINGS

FIG. 1 is a simplified, representative block diagram of a device according to one embodiment of the present invention;

FIG. 2 is a simplified, representative block diagram of a system according to one embodiment of the present invention;

FIGS. 3(a)-(c) are representative embodiments of devices according to the present invention; and

FIG. 4 is a simplified, representative flow chart illustrating an operation of the present invention.

### DETAILED DESCRIPTION OF THE PREFERRED EMBODIMENT(S)

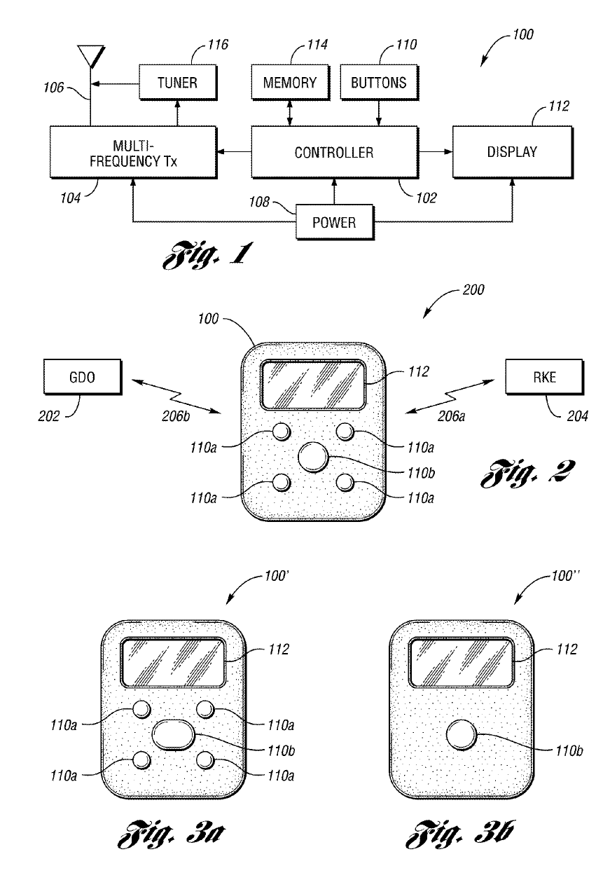

Referring to FIG. 1, a simplified, representative block diagram of a device according to one embodiment of the present invention is shown, generally denoted by reference numeral 100. As seen therein, the device (100), commonly referred to as a “fob” or “card”, generally comprises a controller (102), a programmable multi-frequency transmitter (104), an antenna (106), a power source (108), at least one push-button (110), and a display (112). The device (100) may further comprise a memory device (114) and a programmable tuning circuit (116).

The power source (108) is generally electrically coupled to the controller (102), the multi-frequency transmitter (104), and the display (112) for powering the components. In one embodiment, the power source (108) may be implemented as a battery. However, the power source may be implemented as any appropriate device for generating and/or storing electromotive force to meet the design criteria of a particular application.

The at least one push-button (110) is generally electrically coupled to the controller (102) for interfacing the controller (102) with an operator (i.e., user) (not shown). In one embodiment, a plurality of push-buttons (110) is coupled to the controller (102). As shown in FIG. 2, the set of push-buttons (110) may be grouped according to function into remote keyless entry (RKE) push-buttons (110a) and garage door opener (GDO) pushbuttons (110b). In general, the RKE push-buttons (110a) may be selectively activated by an operator to generate a RKE demand signal (i.e., a RKE operator demand signal) for locking or unlocking vehicle doors, opening or closing a vehicle sliding door, unlocking a vehicle trunk, activating internal and/or external vehicle lights, activating a “panic” alarm, and/or performing a variety of other vehicle related functions. Similarly, the GDO pushbuttons (110b) may be selectively activated by an operator to generate a GDO demand signal (i.e., GDO operator demand signal) for opening (i.e., raising) or closing (i.e., lowering) a garage door, activating (i.e., turning on) or deactivating (i.e., turning off) a light implemented on the control unit, and the like. It should be noted that while the present invention has been described herein as implementing push-buttons (110), any appropriate man-machine interface device (e.g., touch screen, switch, and the like) may be implemented to meet the design criteria of a particular application.

In another embodiment of the present invention, a passive RKE circuit (not shown) may be substituted for the RKE push-buttons (110a) such that a RKE demand signal is generated in response to the position of the device (100) in relation to a vehicle implementing a passive RKE system.

Still referring to FIG. 1, the controller (102) is generally implemented as a logical device. In one embodiment, the controller (102) may be a microprocessor. In another embodiment, the controller (102) may be a microcontroller. In yet another embodiment, the controller (102) may be an application specific integrated circuit (ASIC). However, the controller (102) may be implemented as any appropriate logical device to meet the design criteria of a particular application.

The controller (102) is generally electrically coupled to the push-buttons (110) and/or the passive RKE circuit for receiving the RKE demand signals and/or the GDO demand signals. In addition, the controller (102) may be electrically coupled to a memory device (114).

The memory device (114) may be implemented by any of a number of known physical devices capable of storing data. Such devices may include PROM, EPROM, EEPROM, flash memory, and the like.

In one embodiment, the controller (102) determines a transmission frequency and generates a function code in response to an operator demand signal (i.e., a RKE demand signal and/or a GDO demand signal). In another embodiment, the controller (102) responds to an operator demand signal by determining a transmission frequency, generating a function code, and generating a security code.

The controller (102) may determine a transmission frequency by selecting between a first and second transmission frequency wherein the first frequency matches an operating frequency of a target RKE system and the second frequency matches an operating frequency of a target GDO controller. In general, the controller (102) selects the first frequency in response to a RKE demand signal, and selects the second frequency in response to a GDO demand signal.

One or both of the transmission frequencies may be predefined by the device (100) manufacturer and/or be operator configurable. In one embodiment, an operator may configure a frequency for the device by activating at least one button (110) in a predetermined sequence. The predetermined sequence may be referenced to a set of predetermined frequencies stored in the memory (114) such that the desired frequency may be selected. In another embodiment, an operator may configure a frequency by setting dip switches to a state predefined by the manufacturer to correspond to a particular frequency. However, it should be noted that any appropriate interface may be implemented to configure one or more operating frequencies of the device (100).

The controller (102) may generate one or more RKE function codes in response to a RKE demand signal. As already mentioned, the RKE function code may correspond to RKE operations such as locking or unlocking vehicle doors, opening or closing a vehicle sliding door, unlocking a vehicle trunk, activating internal and/or external vehicle lights, activating a “panic” alarm, and/or performing a variety of other functions.

The generated RKE function codes are generally selected from a set of RKE function codes. The set of RKE function codes may be predefined by the device (100) manufacturer or the set may be selected by an operator (i.e., configurable, programmable) from a group of RKE function code sets stored in the memory (114). Each RKE function code set generally corresponds to a different make and/or model of RKE system. In one embodiment, an operator may select a particular RKE function code set from the group of RKE function code sets by activating at least one button (110) in a predetermined sequence. In another embodiment, an operator may select a particular RKE function code set from the group of RKE function code sets by setting dip switches to a state predefined by the manufacturer to correspond to the desired code set. However, it should be noted that any appropriate interface may be implemented to select a RKE function code set for the device (100).

Similarly, the controller (102) may generate one or more GDO function codes in response to a GDO demand signal. As previously mentioned, the GDO function code may correspond to GDO operations such as opening (i.e., raising) or closing (i.e., lowering) a garage door, activating (i.e., turning on) or deactivating (i.e., turning off) a light implemented on the control unit, and the like.

The generated GDO function codes are generally selected from a set of GDO function codes. The set of GDO function codes may be predefined by the device (100) manufacturer or the set may be selected by an operator (i.e., configurable) from a group of GDO function code sets stored in the memory (114). Each GDO function code set generally corresponds to a different make and/or model of GDO system (i.e., GDO controller). In one embodiment, an operator may select a particular GDO function code set from the group of GDO function code sets by activating at least one button (110) in a predetermined sequence. In another embodiment, an operator may select a particular GDO function code set from the group of GDO function code sets by setting dip switches to a state predefined by the manufacturer to correspond to the desired code set. However, it should be noted that any appropriate interface may be implemented to select a GDO function code set for the device (100).

RKE and GDO systems generally implement a security coding scheme to prevent unauthorized operation of the RKE/GDO. In one embodiment, the security coding scheme may be implemented as a hopping code. In another embodiment, the security coding scheme may be implemented as a rolling code. However, the security coding scheme may be implemented as any appropriate coding scheme to meet the design criteria of a particular application.

Accordingly, the controller (102) may generate one or more RKE security codes using a RKE coding scheme in response to a RKE demand signal. Similarly, the controller (102) may generate one or more GDO security codes using a GDO coding scheme in response to a GDO demand signal.

Each RKE/GDO coding scheme is generally predefined by the device (100) manufacturer and/or is operator configurable. In one embodiment, an operator may select a particular RKE and/or GDO coding scheme from a group of coding schemes stored in the controller memory (114) by activating at least one button (110) in a predetermined sequence. In another embodiment, an operator may select a particular RKE and/or GDO coding scheme from a group of coding schemes by setting dip switches to a state predefined by the manufacturer to correspond to the desired coding scheme. However, it should be noted that any appropriate man-machine interface may be implemented to configure one or more RKE and/or GDO coding schemes of the device (100). It should also be noted that the RKE coding scheme may be the same as or different than the GDO coding scheme.

The device (100) may be dedicated and/or universal. A dedicated device (100) is generally a device wherein the frequency, function code set, and coding scheme are predefined by the deice (100) manufacturer. In contrast, the device (100) may be designated as a universal RKE device when the first frequency, the RKE function code set, and/or the RKE coding scheme are operator selectable (i.e., operator configurable). Similarly, the device (100) may be designated as a universal GDO device when the second frequency, the GDO function code set, and/or the GDO coding scheme are operator selectable.

Referring still to FIG. 1, the multi-frequency transmitter (104) may be electrically coupled to the controller (102) for receiving the frequency signal, function codes, and/or security codes generated by the controller (102). The multi-frequency transmitter (102) generally transmits the function codes and/or security codes at the selected frequency via the antenna (106), wherein the antenna (106) is generally electrically coupled to the transmitter (104).

The programmable tuning circuit (116) may be implemented for tuning the antenna (106). The programmable tuning circuit (116) generally determines the transmission frequency of the multi-frequency transmitter (104) and electronically tunes the antenna (106) to the frequency.

The display device (112) may be electrically coupled to the controller (102) for providing feedback to an operator. The feedback may include notification that a function code set has been successfully selected by an operator from the group of function code sets stored in the memory (114), that a function code has been transmitted, that vehicle doors are locked/unlocked, and the like. In one embodiment, the display (112) may be a light emitting diode. In another embodiment, the display (112) may be an alpha-numeric display. In yet another embodiment, the display (112) may be a touch screen such that the display (112) may function as both an input and an output device to the controller (102). However, the device (112) may be implemented as any appropriate operator interface to meet the design criteria of a particular application.

Referring now to FIG. 2, a simplified block diagram of a system (200) according to one embodiment of the present invention is shown. As shown in FIG. 2, the device (100) may wirelessly transmit/receive signals (i.e., the signal 206a) to/from a RKE system (204), respectively. Similarly, the device (100) may wirelessly transmit/receive signals (i.e., the signal 206b) to/from a GDO (202), respectively. The multi-frequency transmitter (104) (shown in FIG. 1) is generally a radio frequency (RF) transmitter and the signals (206) are generally RF signals. However, any appropriate transmitter (104) may be implemented to generate any appropriate type of signal (206) to meet the design criteria of a particular application.

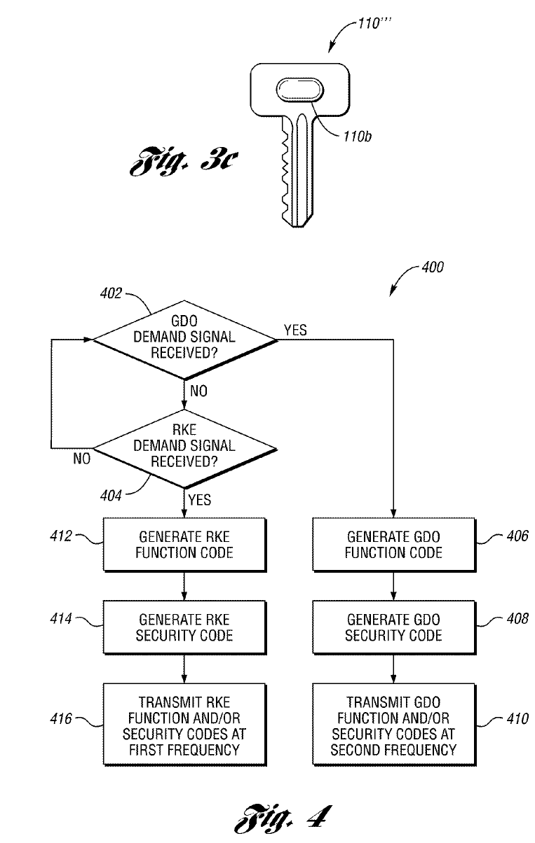

Referring now to FIGS. 3(a)-(c), representative embodiments of devices (100) according to the present invention are shown. FIG. 3(a) illustrates an embodiment (100′) having a plurality of buttons for generating RKE demand signals (i.e., the buttons 110a) and a single button for generating GDO demand signals (i.e., the button 110b). As further shown in FIG. 3(a), the GDO button (110b) may be centrally located between the plurality of RKE buttons (110a).

FIG. 3(b) illustrates an embodiment of the device (100″) for use with a passive RKE system. The device (100″) generally implements a single button for generating GDO demand signals. RKE demand signals are generated by a passive RKE circuit (not shown) within the device (100″) housing. As mentioned previously, the passive RKE circuit may generate RKE demand signals in response to the distance between the device (100″) and a vehicle (not shown) having a complementary passive RKE system.

FIG. 3(c) illustrates an embodiment of the device (100′″) for use with a passive RKE system wherein the RKE/GDO device is incorporated into a vehicle key.

While FIGS. 3(a)-(c) illustrate several representative embodiments of the present invention, these embodiments are representative only. The present invention is broader than the embodiments of FIGS. 3(a)-(c) and may be implemented using any appropriate number of RKE and GDO buttons positioned in any appropriate configuration to meet the design criteria of a particular application.

Referring to FIG. 4, a diagram illustrating an operation (400) (i.e., method, process, procedure, routine, steps, blocks, algorithm, etc.) of the present invention is shown. The method (400) may be advantageously implemented in connection with a device (100) (e.g., the devices 100′, 100″ and 100′″) according to the present invention.

The device (100) generally determines when at least one GDO demand signal has been received (decision step or block 402). When a GDO demand signal has been received (i.e., the YES leg of the decision block 402), the device may generate at least one GDO function code in response to the GDO demand signal (block or step 406). Furthermore, the device may generate at least one GDO security code using a GDO coding scheme in response to the GDO demand signal (step or block 408). At least one of the GDO function code and GDO security code are then, generally, transmitted at a frequency monitored by a target (i.e., complementary) GDO system (e.g., the second frequency).

When a GDO demand signal has not been received (i.e., the NO leg of the decision block 402), the device generally determines if at least one RKE demand signal has been received (decision step or block 404). When a RKE demand signal has not been received (i.e., the NO leg of the decision block 404), the device may continue monitoring for the presence of a GDO demand signal (block or step 402). When a RKE demand signal has been received (i.e., the YES leg of the decision block 404), the device may generate at least one RKE function code in response to the RKE demand signal (block or step 412). Furthermore, the device may generate at least one RKE security code using a RKE coding scheme in response to the RKE demand signal (step or block 414). At least one of the RKE function code and RKE security code are then, generally, transmitted at a frequency monitored by a target (i.e., complementary) RKE system (e.g., the first frequency).

It should be noted that the simplified flow chart depicted in FIG. 4 is exemplary of the method (400) of the present invention. In that regard, the method (400) may be executed in sequences other than those shown in FIG. 4, including the execution of a subset of the steps shown and/or the execution of one or more steps simultaneously.

From the foregoing description, it can be seen that the present invention provides a system and method for integrated garage door opener and remote vehicle entry using a multi-frequency transmitter that overcome the problems associated with the prior art. In that regard, as previously noted, such prior art garage door opener and vehicle remote keyless entry systems are independent, distinct systems. That is, such systems do not interact with one another or share components. The present invention provides a system and method wherein cost is reduced through the use of shared, combined or integrated components. Such a system may further provide space saving and convenience benefits through a single, portable control unit.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A portable device for controlling a vehicle remote keyless entry (RKE) system and a garage door opener (GDO), the device comprising:
a controller for generating a function code in response to an operator demand signal and for selecting between a first and second transmission frequency, wherein the operator demand signal is at least one of a RKE demand signal and a GDO demand signal, and the first frequency is selected when the function code is generated in response to a RKE demand signal and the second frequency is selected when the function code is generated in response to a GDO demand signal; and
a multi-frequency transmitter electrically coupled to the controller and an antenna for transmitting the generated function code to at least one of a vehicle remote keyless entry system and a garage door opener at the selected frequency.

2. The portable device of claim 1 wherein at least one of the first and second frequencies is determined by an operator activating at least one button on the portable device in a predetermined sequence.

3. The portable device of claim 1 wherein at least one of the first and second frequencies is determined by an operator setting dip switches on the portable device.

4. The portable device of claim 1 wherein the controller generates a security code using a RKE coding scheme in response to a RKE demand signal, the controller generates a security code using a GDO coding scheme in response to a GDO demand signal, and the multi-frequency transmitter transmits the security code with the function code at the selected frequency.

5. The portable device of claim 4 wherein at least one of the RKE and GDO coding schemes is selected from a set of coding schemes stored in a controller memory by an operator activating at least one button on the portable device in a predetermined sequence.

6. The portable device of claim 1 wherein the RKE demand signal is generated in response to the operator activating a button on the portable device.

7. The portable device of claim 1 wherein the remote keyless entry system is passive and the RKE demand signal is generated in response to the proximity of the portable device to a vehicle having the vehicle remote keyless entry system.

8. The portable device of claim 1 further comprising a programmable tuning circuit such that the antenna is tuned in response to the selected frequency.

9. The portable device of claim 1 further comprising a light emitting diode for providing feedback to an operator.

10. The portable device of claim 1 further comprising at least one of an alpha-numeric display and a touch screen for providing feedback to an operator.

11. The portable device of claim 1 wherein the portable device is integrated into a vehicle key.

12. A system for controlling a vehicle remote keyless entry system (RKE) and a garage door opener (GDO), the system comprising:
a portable device for electronically communicating with the RKE and the GDO, wherein the device includes a controller electrically coupled to a multi-frequency transmitter such that the controller generates and the transmitter transmits a RKE function code at a first frequency in response to a RKE operator demand signal, and the controller generates and the transmitter transmits a GDO function code at a second frequency in response to a GDO operator demand signal.

13. The system of claim 12 wherein at least one of the first and second frequencies is determined by an operator activating at least one button on the portable device in a predetermined sequence.

14. The system of claim 12 wherein the controller generates and the transmitter transmits a RKE security code in response to a RKE operator demand signal, and the controller generates and the transmitter transmits a GDO security code in response to a GDO operator demand signal.

15. The system of claim 14 wherein the controller further includes a memory for storing a set of coding schemes, at least one of a RKE coding scheme and a GDO coding scheme is selected from the set of coding schemes by an operator activating at least one button on the portable device, the controller generates the RKE security code using the RKE coding scheme, and the controller generates the GDO security code using the GDO coding scheme.

16. The system of claim 12 wherein the portable device further includes at least one of a light emitting diode, an alpha-numeric display, and a touch screen for providing feedback to an operator.

17. The system of claim 12 wherein the portable device further includes a programmable tuning circuit such that the antenna is tuned in response to the transmission frequency.

18. A method for controlling a vehicle remote keyless entry (RKE) system having a first operating frequency and a garage door opener (GDO) having a second operating frequency using a portable device having a controller electrically coupled to a multi-frequency transmitter, the method comprising:
determining when at least one of a RKE operator demand signal and a GDO operator demand signal is presented to the controller;
generating a RKE function code and a RKE security code using a predetermined RKE coding scheme when a RKE operator demand signal is presented to the controller;
generating a GDO function code and a GDO security code using a predetermined GDO coding scheme when a GDO operator demand signal is presented to the controller;
transmitting the RKE function code and the RKE security code at the first frequency using the multi-frequency transmitter when a RKE operator demand signal is presented to the controller; and
transmitting the GDO function code and the GDO security code at the second frequency using the multi-frequency transmitter when a GDO operator demand signal is presented to the controller.

19. The method of claim 18 further including the steps of electrically coupling an antenna to the multi-frequency transmitter, and tuning the antenna using a programmable tuning circuit.

20. The method of claim 18 further including the step of providing feedback to an operator using at least one of a light emitting diode, an alpha-numeric display, and a touch screen.
